(19) United States
(12) Patent Application Publication
(10) Pub. No.: US 2007/0171665 A1
(43) Pub. Date: Jul. 26, 2007

(54) High-intensity zone LED projector

(75) Inventor: Timothy S. Finch, Louisville, CO (US)

Correspondence Address: ICE MILLER LLP, ONE AMERICAN SQUARE, SUITE 3100, INDIANAPOLIS, IN, 46282-0200, US

(73) Assignee: Guide Corporation

(21) Appl. No.: 11/338,038

(22) Filed: Jan. 24, 2006

(51) Int. Cl. F21V 7/00

(52) U.S. Cl. 362/516

(57) ABSTRACT

A headlamp assembly is provided having a horizontal longitudinal optical axis that runs generally the length of a vehicle utilizing the headlamp assembly. The headlamp assembly may include a top reflector that extends in the half-space situated above a horizontal axial plane that passes through the longitudinal optical axis. The top reflector may include a reflective interior surface. The assembly may also include a pair of bottom reflectors that extend in the half-space situated below the horizontal axial plane, each of which may also include a reflective interior surface. Three light emitting diodes each having a light diffusion axis that is substantially perpendicular to the horizontal axial plane may be positioned near the first focus of each reflector. Each reflector may have substantially the same second focus, such that light energy emitted by the light emitting diodes is focused at the same focal point. A condensing lens is positioned in the assembly so that its focal plane is near the common focal point. A cutoff shield is positioned in the assembly between the reflectors and the condensing lens in order to form a high-intensity zone of the headlamp assembly's illumination beam.

### BACKGROUND

1. Technical Field

The present invention relates generally to automobile headlamps and other forward lighting applications, and more particularly, to a projector headlamp using light emitting diodes as the light source.

2. Background Information

Projector headlamps typically include a light bulb positioned within an elliptical reflector, a front condensing lens, and a cutoff shield between the lens and the light source. Lamps of the elliptical type, or lamps with image reproduction optics, are well known, in particular for the production of an illumination beam with a cutoff. An illumination beam with a cutoff refers to an illumination beam that has a directional limit, or cutoff, above which the emitted light intensity is low. Low beam headlights and fog lights are examples of illumination beams with a cutoff, (i.e., the type of low beam headlights manufactured in accordance with the regulations of various European nations).

Generally, in an elliptical lamp, the cutoff is implemented by means of a screen, which is formed from a vertical plate of an adapted profile, which is interposed axially between the elliptical reflector and the convergent (condensing) lens, and which is arranged in the vicinity of the second focus of the reflector. The screen makes it possible to mask the light rays originating from the light source and reflected by the reflector towards the lower part of the focal plane of the convergent lens, and which would, in the absence of the screen, be emitted by the lamp above the cutoff.

The document U.S. Pat. No. 4,914,747 discloses a lamp having a reflector that comprises upper and lower parts in the shape of semi-ellipsoids with the same optical axis, the second foci of which are coincident, the first focus of the upper reflector being situated in front of that of the lower reflector. The lamp comprises a bulb with two filaments, each disposed at one of the first foci of the reflectors. A flat screen is disposed parallel to the optical axis of the reflectors, the front edge of this screen being disposed in the vicinity of the second foci, themselves coinciding with the focus of a convergent lens.

The document EP-A-1 193 440 discloses a lamp producing an illumination beam having a cutoff, comprising a semi-elliptical reflector, a light source arranged in the vicinity of the first focus of the reflector, a convergent lens whose focal plane is arranged in the vicinity of the second focus of the reflector, and a horizontal flat surface of reflection, the upper face of which is reflective. The flat surface has a front end edge which is arranged in the vicinity of the second focus of the reflector, so as to form the cutoff in the illumination beam. The flat surface is mounted at and able to pivot about its rear edge so as to form a low beam when it is parallel to the optical axis, and a high beam when it is switched over.

Light emitting diodes are a desirable feature for the light source in modem automobile headlamps and other forward lighting applications. Light emitting diodes generally have a higher efficiency than their incandescent and/or halogen bulb predecessors. Light emitting diodes are also smaller in size and generally allow for smaller lamps with numerous different designs possible.

U.S. Publication No. 2000/0214815 A1 to Ishida et al. (“Ishida”) discloses a projection-type vehicular lighting unit with a light emitting diode positioned within an elliptical reflector so that the light emitting diode's light emitting portion is perpendicular to the optical axis and emits light upward into the reflector.

The document U.S. Patent No. 6,565,247 B2 to Thominet (“Thominet”) discloses a headlamp assembly that utilizes a plurality of semi-conductor light sources positioned behind a lens and a screen. The screen is positioned under an optical axis so that the screen blocks a portion of the light emitted from the semiconductor light sources to produce a bright-dark limit of the light beam.

Most light emitting diode headlamps that have been designed to date generally have two drawbacks. First, most light emitting diode headlamp designs do not have a sharp cutoff in the high-intensity zone of the desired beam pattern. A sharp light cutoff is desirable between the high-intensity zone and the area above the high-intensity zone, (i.e., the “hotspot” of the light beam) not only to meet government standards, but also to provide as much light as possible on the road for the driver while avoiding glare in the eyes of oncoming traffic. Second, most light emitting diode headlamp designs do not provide the necessary luminance required for an effective headlamp light beam, as required by the laws of most nations.

It would be desirable to provide a light emitting diode headlamp assembly that has a sharp cutoff in the high-intensity zone of the beam pattern. It would be further desirable to provide a light emitting diode headlamp assembly that provides the necessary luminance required for an effective headlamp light beam.

### BRIEF SUMMARY

In one illustrative embodiment, a headlamp assembly having a horizontal longitudinal optical axis may include a top reflector that extends in the half-space situated above a horizontal axial plane that passes through the longitudinal optical axis. The top elliptical reflector includes a reflective interior surface having a first focus and a second focus. The headlamp assembly may also include a bottom reflector that extends in the half-space situated below the horizontal axial plane, wherein the bottom elliptical reflector comprises a reflective interior surface having a third focus and a fourth focus.

Additionally, the headlamp assembly may include a top light emitting diode having a light diffusion axis that is substantially perpendicular to the horizontal axial plane and positioned near the first focus, and a bottom light emitting diode having a light diffusion axis that is substantially perpendicular to the horizontal axial plane and positioned near the third focus. A condensing lens may be included in the headlamp assembly such that the lens's focal plane is near the second focus. The assembly may also include a cutoff shield positioned between the bottom reflector and the condensing lens.

The light diffusion axis of the top light emitting diode may substantially face the reflective interior surface of the top reflector. Likewise, the light diffusion axis of the bottom light emitting diode may substantially face the reflective interior surface of the bottom reflector. The second focus may be in substantially the same location as then forth focus such that light emitted by the top light emitting diode and light emitted by the bottom light emitting diode passes through a common focal point. The reflective interior surface of the top reflector may be substantially elliptical, such as an angular sector generated by revolution. The top and bottom light emitting diodes may each include a Lambertian Luxeon emitter and a collecting elliptical reflector. The condensing lens may be positioned confocal to the cutoff shield.

In a further illustrative embodiment, a projection headlamp assembly may include a plurality of light emitting diodes and a plurality of reflectors positioned behind a single cutoff shield to form the high-intensity zone of the projection headlamp's light beam. The projection headlamp assembly may focus light from the plurality of light emitting diodes at a common focal point by positioning at least one light emitting diode perpendicular to the optical axis so that the light emitting portion will emit light upward into a corresponding reflector and by positioning at least one light emitting diode perpendicular to the optical axis so that the light emitting portion will direct light downward into a corresponding reflector in order to focus the light emitting diodes at the same point.

In another illustrative embodiment, a projection headlamp assembly may include a first light emitting diode positioned perpendicular to an optical axis so that the first light emitting diode's light emitting portion emits light upward into a first corresponding reflector so that emitted light from the first light emitting diode is directed towards a focal point. The projection headlamp assembly may also include a second light emitting diode positioned perpendicular to the optical axis so that the second light emitting diode's light emitting portion emits light downward into a corresponding second reflector and so that emitted light from the second light emitting diode is directed towards the focal point. The projection headlamp assembly may also include a cutoff shield positioned in front of both of the first and second light emitting diodes and corresponding first and second reflectors.

In a further illustrative embodiment, a headlamp assembly is provided having a horizontal longitudinal optical axis that runs generally the length of a vehicle utilizing the headlamp assembly. The headlamp assembly may include a top reflector that extends in the half-space situated above a horizontal axial plane that passes through the longitudinal optical axis. The top reflector may include a reflective interior surface. The assembly may also include a pair of bottom reflectors that extend in the half-space situated below the horizontal axial plane, each of which may also include a reflective interior surface.

The headlamp assembly may include a plurality of light emitting diodes, each having a light diffusion axis that is substantially perpendicular to the horizontal axial plane and positioned near the first focus of one of the reflectors. Each reflector may have substantially the same second focus, such that light energy emitted by the light emitting diodes is focused at the same focal point. A condensing lens may be positioned in the assembly so that the lens's focal plane is near the common focal point. A cutoff shield may be positioned in the assembly between the reflectors and the condensing lens in order to form a high-intensity zone of an illumination beam generated by the headlamp assembly.

### BRIEF DESCRIPTION OF THE DRAWINGS

FIG. 1 is a perspective view of a projector headlamp in accordance with the present invention;

FIG. 2 is a top view of a projector headlamp in accordance with the present invention;

FIG. 3 is a front view of a projector headlamp in accordance with the present invention; and

FIG. 4 is a side view of a projector headlamp in accordance with the present invention.

FIG. 5 is a side view of a projector headlamp in accordance with the present invention having a movable cutoff shield.

### DETAILED DESCRIPTION OF THE DRAWINGS AND PRESENTLY PREFERRED EMBODIMENTS

The present invention relates to a projector headlamp using light emitting diodes as the light source. Projector headlamps typically include a light source positioned within an elliptical reflector, a front condensing lens and a cutoff shield between the lens and the light source.

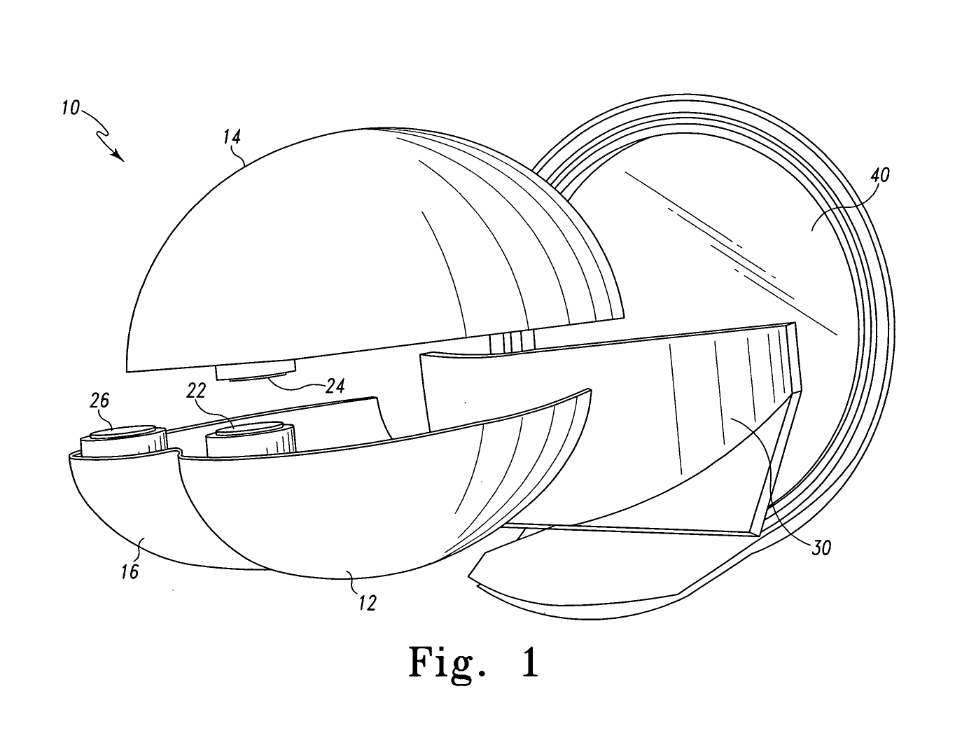

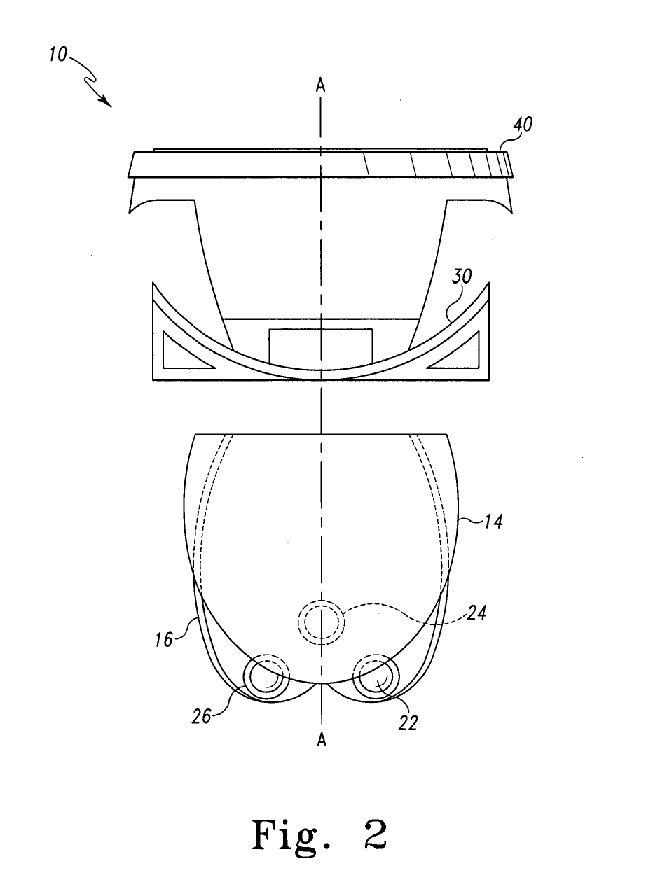

Turning to FIG. 1, a light emitting diode projector headlamp 10 (headlamp assembly) is shown in a perspective view. The light emitting diode projector headlamp 10 provides a high-intensity zone with a sharp cutoff. The light emitting diode projector headlamp 10 comprises, arranged from back to front along a horizontal longitudinal optical axis A-A (shown in FIG. 2), elliptical reflectors 12, 14, and 16, light emitting diodes 22, 24, and 26, a cutoff shield 30, and a condensing lens 40.

Components of the light emitting diode projector headlamp 10 are shown “floating in space” in order to simplify the description of the optical interactions between the components. In a manufactured assembly implanting the light emitting diode projector headlamp 10, the components thereof may be fixed in place by a structure, such as an injection molded or blow molded plastic shell, the precise composition of which is not relevant to the optical functionality of the light emitting diode projector headlamp 10.

For example, the elliptical reflectors 12, 14, and 16 may each be a reflectively coated internal surface of an integrated injection molded plastic shell. The reflective coating could be chrome, silver, platinum, Mylar, or the like. Alternatively, the elliptical reflectors 12, 14, and 16 may be polished portions of a metal housing, in which case the internal reflective surfaces of the elliptical reflectors 12, 14, and 16 could be coated with glass, plastic, or another such protective coating.

The cutoff shield 30 may also be fabricated from injection molded plastic, cast or machined metal, or any other common manufacturing material. The cutoff shield 30 may also be an integral part of an injection molded plastic shell that forms the elliptical reflectors 12, 14, and 16. Similarly, the condensing lens 40 may be manufactured from plastic, glass, or another transparent material suitable for the production of optical lenses.

The condensing lens 40 may be affixed to a lamp housing (such as a plastic or metal shell, not shown) that forms the elliptical reflectors 12, 14, and 16 and the cutoff shield 30, and the entire assembly may be sealed to prevent moisture from entering the light emitting diode projector headlamp 10 and condensing on the elliptical reflectors 12, 14, and 16 or on the condensing lens 40.

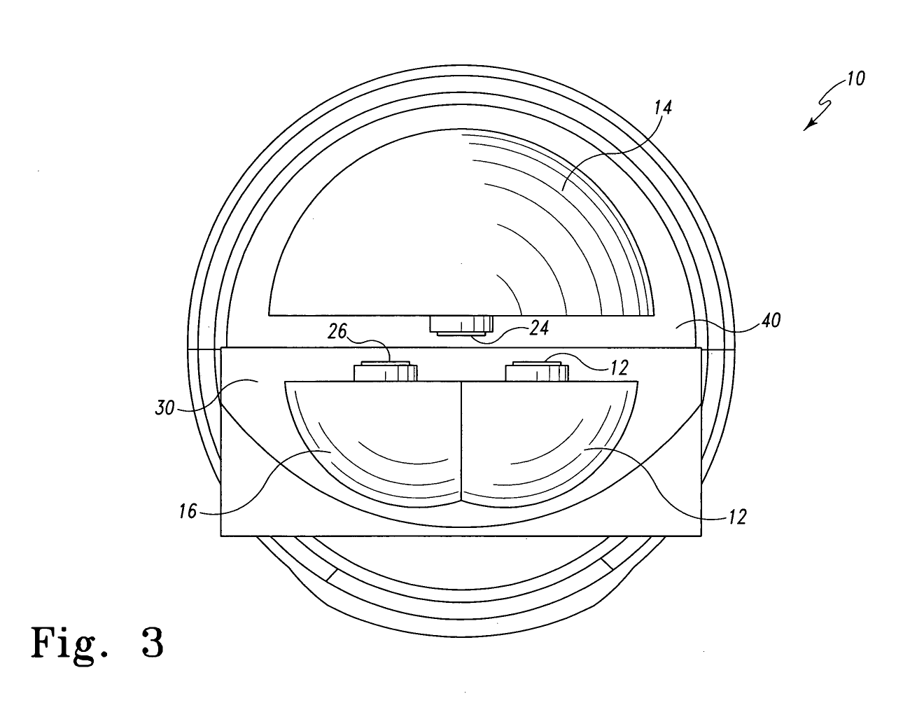

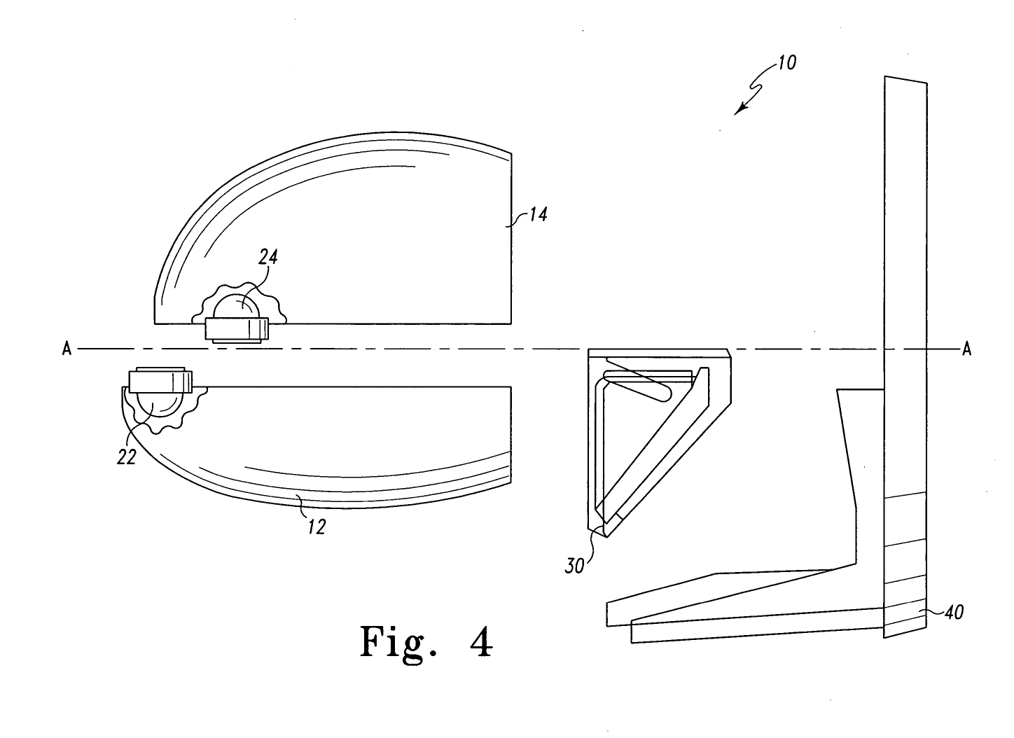

The optical axis A-A shown and described herein defines, for purposes of illustration only and not to limit the claims attached hereto, a horizontal longitudinal direction in an orientation from back to front, which corresponds to an orientation from bottom to top in FIG. 2, an orientation from left to right in FIG. 4, and an orientation “into the page” in FIG. 3. The optical axis A-A may be, for example, substantially parallel to the longitudinal axis of a vehicle (not shown) equipped with the light emitting diode projector headlamp 10.

The internal face of each of the elliptical reflectors 12, 14, and 16 is reflective. In the illustrative embodiment depicted herein, the elliptical reflectors 12, 14, and 16 each has an elliptical surface that is implemented in the form of an angular sector of a component substantially generated by revolution, and which extends in the half-space situated above (for the elliptical reflector 14) and below (for the elliptical reflectors 12 and 16) a horizontal axial plane passing through the longitudinal optical axis A-A.

It should be noted that the elliptical reflectors 12, 14, and 16 do not have to be perfectly elliptical, and each may have one of a number of specific profiles provided for optimizing the light distribution in an illumination beam produced by the light emitting diode projector headlamp 10, according to the illumination function implemented by the light emitting diode projector headlamp 10. In other words, the elliptical reflectors 12, 14, and 16 need not be perfectly generated by revolution, and could be another shape, such as parabolic, without substantially affecting the operation of the light emitting diode projector headlamp 10. The term “elliptical” refers only to the illustrative embodiment of reflectors described herein, and is not intended to limit the claimed invention to using only elliptical reflectors, as it is known in the art that other geometries of reflectors may be used with similar results in lighting applications.

The elliptical reflectors 12, 14, and 16 delimit a volume of reflection for the light rays emitted by the light emitting diodes 22, 24, and 26; in other words a volume in which the light rays are emitted and in which the light rays are reflected. This volume of reflection is delimited, in its upper part, by the reflective face of the elliptical reflector 14, and vertically towards the bottom by the reflective faces of the elliptical reflectors 12 and 16.

The condensing lens 40 may be a component generated by revolution about the longitudinal optical axis A-A. The condensing lens 40 may have, facing the elliptical reflectors 12, 14, and 16, a transverse input surface for the light rays generated by the light emitting diodes 22, 24, and 26 and focused by the elliptical reflectors 12, 14, and 16.

Each light emitting diode 22, 24, and 26 may comprise a semiconductor junction that produces light energy, and a light diffusion cover or case that encloses the upper part of the semiconductor junction. Each of the light emitting diodes 22, 24, and 26 may be, in one preferred embodiment, a Lambertian Luxeon emitter having its own collecting elliptical reflector, as known in the art. The light emitting diodes 22, 24, and 26 may be mounted on an electronic support board (not shown), wherein said electronic support board may be arranged parallel to the horizontal axial plane passing through the longitudinal optical axis A-A.

Each light emitting diode 22, 24, and 26 may have light diffusion axis that is here substantially perpendicular to a horizontal axial plane passing through the longitudinal optical axis A-A. Each of the light emitting diodes 22, 24, and 26 may emit light energy in an angle that is less than 180 degrees, which angle is generally centered around the respective light diffusion axis of the light emitting diode 22, 24, or 26. In such an arrangement, each of the light emitting diodes 22, 24, and 26 emits the majority of its light energy towards the internal reflective face of the respective elliptical reflector 12, 14, or 16.

Referring generally to FIGS. 1-4, the individual optical axis of each light emitting diode 22, 24, and 26 is generally perpendicular to the horizontal longitudinal optical axis A-A of the light emitting diode projector headlamp 10. The light emitting diode 22 is associated with elliptical reflector 12, the light emitting diode 24 is associated with elliptical reflector 14, and the light emitting diode 26 is associated with elliptical reflector 16. Each light emitting diode 22, 24, and 26 is arranged in the vicinity of a first focus of the respective elliptical reflector 12, 14, and 16. The condensing lens 40 has a focal plane that is arranged in the vicinity of the second focus of the elliptical reflectors 12, 14, and 16, so that each elliptical reflector 12, 14, and 16 generally focuses the light from the associated light emitting diode 22, 24, and 26 through a common focal point. The elliptical reflectors 12, 14, and 16 and the condensing lens 40 form the optical system of the light emitting diode projector headlamp 10.

FIGS. 1-4 show a single elliptical reflector 14 as a top reflector, and two partial elliptical reflectors 12 and 16 as bottom reflectors. However, any combination of these light emitting diodes 22, 24, and 26 and the elliptical reflectors 12, 14, and 16 is possible. For example, the bottom reflector could be single elliptical reflector 14. Likewise, the top reflector could comprise double partial elliptical reflectors 12 and 16, or could comprise a triple partial elliptical reflector (not shown).

In order to focus the light from the associated light emitting diode 24 through a common focal point, top elliptical reflector 14 directs light in a generally forward and downward direction, and the bottom elliptical reflectors 12 and 16 direct light from the associated light emitting diodes 22 and 26 in a generally forward and upward direction. As noted above, the condensing lens 40 is provided forward of the light emitting diodes 22, 24, and 26, and the cutoff shield 30 is provided between the elliptical reflectors 12, 14, and 16 and the condensing lens 40. The common focal point of the elliptical reflectors 12, 14, and 16 is located in front of the cutoff shield 30. Thus, the cutoff shield 30 blocks a significant amount of light from the bottom elliptical reflectors 12 and 16 before the light passes through the common focal point.

The blocking action of the cutoff shield 30 decreases the amount of light that is emitted from the light emitting diode projector headlamp 10 in a generally upward direction, which is light that if it were not blocked could potentially cause glare for oncoming traffic. Furthermore, the cutoff shield 30 provides a sharp cutoff in the high-intensity zone of a resulting illumination beam emitted by the light emitting diode projector headlamp 10. The illumination beam created by the light emitting diode projector headlamp 10 generally forms the high-intensity zone of an illumination beam pattern, and an auxiliary headlamp may be used with the light emitting diode projector headlamp 10 to supplement the illumination beam pattern.

In summary, the light emitting diode projector headlamp 10 shown in FIGS. 1-4 utilizes the cutoff shield 16 as an effective way of obtaining a sharp cutoff in the high-intensity zone of the illumination beam pattern. Additionally, the light emitting diode projector headlamp 10 shown in FIGS. 1-4 utilizes a plurality of light emitting diodes 22, 24, and 26 focused on the same point in order to produce a high luminance value for the light emitting diode projector headlamp 10, and also to generate a desirable beam pattern.

The light emitting diode projector headlamp 10 shown in FIGS. 1-4 implements a projector optic design that provides the high-intensity zone light in a forward lighting application. The basic premise of the implemented projector optic design is that the plurality of light emitting diodes 22, 24, and 26, which are preferably Lambertian Luxeon emitters having integral collecting elliptical reflectors, are located confocal to the cutoff shield 30 of the light emitting diode projector headlamp 10. The condensing lens 40 is positioned confocal to the cutoff shield 30 to facilitate proper beam shaping.

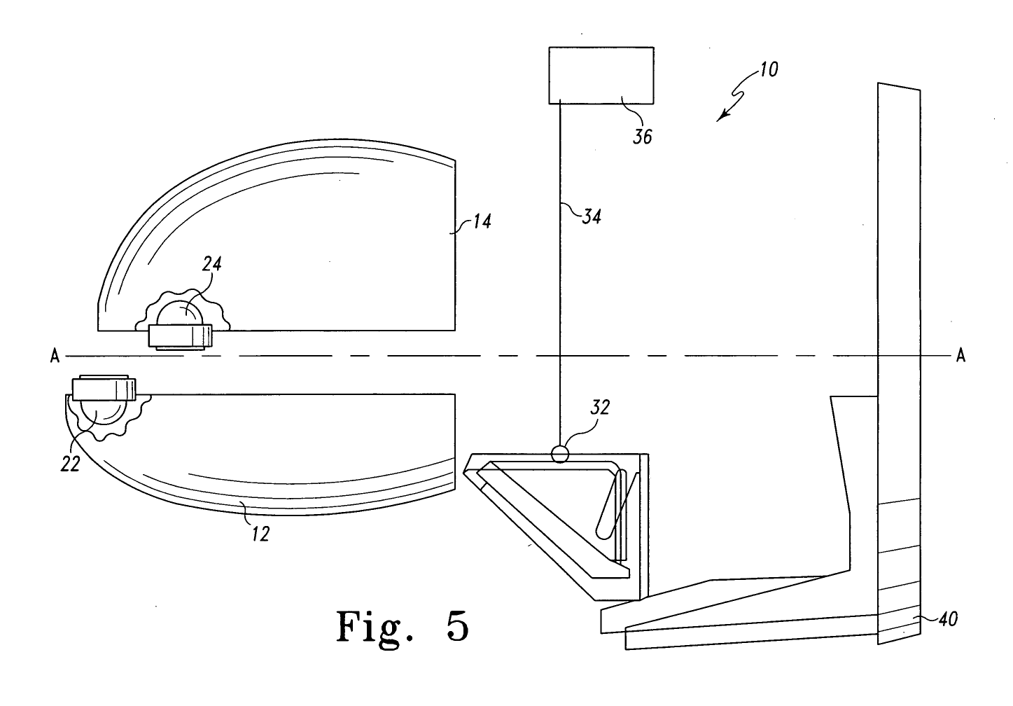

In the embodiment shown in FIGS. 1-4, the light emitting diode projector headlamp 10 is functional to provide the high-intensity zone light for a low beam application. Turning to FIG. 5, the light emitting diode projector headlamp 10 is made bi-functional, so that the cutoff shield 30 is moveable. In the illustrative embodiment shown in FIG. 5, the light emitting diode projector headlamp 10 is functional to provide both low beam and high beam illumination patterns.

Shown in FIG. 5 is the light emitting diode projector headlamp 10 with the addition of a shaft 32, an arm 34, and an actuator 36. The shaft 32 provides a pivot point for the cutoff shield 30, so that the cutoff shield 30 is movable between a first position and a second position. In the first position (engaged) shown in FIG. 4, the light emitting diode projector headlamp 10 is functional to provide the high-intensity zone light for a low beam application. In the second position (disengaged), shown in FIG. 5, the light emitting diode projector headlamp 10 is functional to provide the high-intensity zone light for a high beam application.

The location for mounting the shaft 32 to cutoff shield 30 may vary with other design considerations, and the mounting location shown in FIG. 5 is for illustrative purposes only and is not intended to limit the claimed invention in any way. The actuator 36 may be any rotary or linear motor functional to exert force on arm 34 in a first and a second direction. If the arm 34 is rotatable, for example coupled to the shaft 32 via a universal joint, then a rotary motor would be preferred. If the arm 34 is of the “push-pull” type, then either a linear motor or a rotary motor with a short shaft would be preferred. The use of bi-functional (movable between two positions) cutoff shields is well known in the art, and various methods for modifying the embodiment of the light emitting diode projector headlamp 10 shown in FIG. 5 will be apparent.

Throughout this specification, unless the context requires otherwise, the words “comprise” and “include” and variations such as “comprising” and “including” will be understood to imply the inclusion of an item or group of items, but not the exclusion of any other item or group items.

While various embodiments of the invention have been described, it will be apparent to those of ordinary skill in the art that many more embodiments and implementations are possible within the scope of the invention. Furthermore, although various indications have been given as to the scope of this invention, the invention is not limited to any one of these but may reside in two or more of these combined together. Accordingly, the invention is not to be restricted except in light of the attached claims and their equivalents.

I claim:

1. A headlamp assembly having a horizontal longitudinal optical axis, the assembly comprising:
a top reflector that extends in the half-space situated above a horizontal axial plane, wherein the horizontal axial plane passes through the longitudinal optical axis, and wherein the top elliptical reflector comprises a reflective interior surface having a first focus and a second focus;
a bottom reflector that extends in the half-space situated below the horizontal axial plane, wherein the bottom elliptical reflector comprises a reflective interior surface having a third focus and a fourth focus;
a top light emitting diode having a light diffusion axis that is substantially perpendicular to the horizontal axial plane, wherein the top light emitting diode is positioned near the first focus so that light emitted by the top light emitting diode will enter into the top reflector;
a bottom light emitting diode having a light diffusion axis that is substantially perpendicular to the horizontal axial plane, wherein the bottom light emitting diode is positioned near the third focus so that light emitted by the bottom light emitting diode will enter into the bottom reflector;
a condensing lens having a focal plane, wherein the condensing lens is positioned so that the focal plane of the condensing lens is near the second focus; and
a cutoff shield positioned between the bottom reflector and the condensing lens.

2. The headlamp assembly of claim 1, wherein the light diffusion axis of the top light emitting diode substantially faces the reflective interior surface of the top reflector.

3. The headlamp assembly of claim 1, wherein the light diffusion axis of the bottom light emitting diode substantially faces the reflective interior surface of the bottom reflector.

4. The headlamp assembly of claim 1, wherein the second focus is in substantially the same location as the fourth focus.

5. The headlamp assembly of claim 1, wherein the second focus is in substantially the same location as the fourth focus, such that light emitted by the top light emitting diode and light emitted by the bottom light emitting diode passes substantially through a common focal point.

6. The headlamp assembly of claim 1, wherein the reflective interior surface of the top reflector is substantially elliptical.

7. The headlamp assembly of claim 1, wherein the reflective interior surface of the top reflector is an angular sector generated by revolution.

8. The headlamp assembly of claim 1, wherein the reflective interior surface of the bottom reflector is substantially elliptical.

9. The headlamp assembly of claim 1, wherein the reflective interior surface of the bottom reflector is an angular sector generated by revolution.

10. The headlamp assembly of claim 1, wherein the top light emitting diode comprises a Lambertian Luxeon emitter and a collecting reflector.

11. The headlamp assembly of claim 1, wherein the cutoff shield is movable between a first position and a second position.

12. The headlamp assembly of claim 1, wherein the condensing lens is positioned confocal to the cutoff shield.

13. A headlamp assembly having a horizontal longitudinal optical axis, the assembly comprising
a top reflector that extends in the half-space situated above a horizontal axial plane, wherein the horizontal axial plan passes through the longitudinal optical axis, and wherein the top elliptical reflector comprises a reflective interior surface having a first focus and a second focus;
a first bottom reflector that extends in the half-space situated below the horizontal axial plane, wherein the fist bottom elliptical reflector comprises a reflective interior surface having a third focus and a fourth focus;
a second bottom reflector that extends in the half-space situated below the horizontal axial plane, wherein the second bottom elliptical reflector comprises a reflective interior surface having a fifth focus and a sixth focus;
a top light emitting diode having a light diffusion axis that is substantially perpendicular to the horizontal axial plane and positioned near the first focus so that light emitted by the top light emitting diode will enter into the top reflector;
a first bottom light emitting diode having a light diffusion axis that is substantially perpendicular to the horizontal axial plane and positioned near the third focus so that light emitted by the bottom light emitting diode will enter into the bottom reflector;
a second bottom light emitting diode having a light diffusion axis that is substantially perpendicular to the horizontal axial plane and positioned near the fifth focus so that light emitted by the bottom light emitting diode will enter into the bottom reflector;
a condensing lens having a focal plane, wherein the condensing lens is positioned so that the focal plane of the condensing lens is near the second focus; and
a cutoff shield positioned between the first bottom reflector and the condensing lens.

14. The headlamp assembly of claim 13, wherein the reflective interior surface of the top reflector is substantially elliptical.

15. The headlamp assembly of claim 13, wherein the reflective interior surface of the first bottom reflector is substantially partially elliptical.

16. The headlamp assembly of claim 13, wherein the reflective interior surface of the first bottom reflector is substantially partially elliptical, and the reflective interior surface of the second bottom reflector is substantially partially elliptical.

17. The headlamp assembly of claim 13, wherein a light diffusion axis of the top light emitting diode substantially faces the reflective interior surface of the top elliptical reflector.

18. The headlamp assembly of claim 13, wherein a light diffusion axis of the first bottom light emitting diode substantially faces the reflective interior surface of the first bottom elliptical reflector.

19. The headlamp assembly of claim 13, wherein a light diffusion axis of the first bottom light emitting diode substantially faces the reflective interior surface of the first bottom elliptical reflector, and the light diffusion axis of the second bottom light emitting diode substantially faces the reflective interior surface of the second bottom elliptical reflector.

20. The headlamp assembly of claim 13, wherein the second focus is in substantially the same location as the forth focus.

21. The headlamp assembly of claim 13, wherein the second focus is in substantially the same location as the forth focus and the sixth focus.

22. The headlamp assembly of claim 13, wherein the cutoff shield is movable between a first position and a second position.

23. A headlamp assembly having horizontal longitudinal optical axis, the assembly comprising
a top reflector that extends in the half-space situated above a horizontal axial plane, wherein the horizontal axial plan passes through the longitudinal optical axis and the top elliptical reflector comprises a reflective interior surface having a first focus and a second focus;
a first bottom reflector that extends in the half-space situated below the horizontal axial plane, wherein the fist bottom elliptical reflector comprises a reflective interior surface having a third focus and a fourth focus;
a second bottom reflector that extends in the half-space situated below the horizontal axial plane, wherein the second bottom elliptical reflector comprises a reflective interior surface having a fifth focus and a sixth focus;
a top light emitting diode having a light diffusion axis that is substantially perpendicular to the horizontal axial plane and positioned near the first focus;
a first bottom light emitting diode having a light diffusion axis that is substantially perpendicular to the horizontal axial plane and positioned near the third focus;
a second bottom light emitting diode having a light diffusion axis that is substantially perpendicular to the horizontal axial plane and positioned near the fifth focus
a condensing lens having a focal plane, where the condensing lens is positioned so that the focal plane of the condensing lens is near the second focus; and
a cutoff shield positioned between the first and second bottom reflectors and the condensing lens;
wherein the second, fourth and sixth focuses are substantially the same such that light energy emitted by the top light emitting diode, first bottom light emitting diode and second bottom light emitting diode is focused at the same focal point, and the condensing lens is positioned confocal to the cutoff shield.

24. The headlamp assembly of claim 23, wherein the cutoff shield is movable between a first position and a second position.
